(19) United States
(12) Patent Application Publication
(10) Pub. No.: US 2019/0018306 A1
(43) Pub. Date: Jan. 17, 2019

(54) PROJECTOR AND METHOD FOR CONTROLLING PROJECTOR

(71) Applicant: SEIKO EPSON CORPORATION, Tokyo (JP)

(72) Inventor: Hirofumi KASUGA, Matsumoto-shi (JP)

(73) Assignee: SEIKO EPSON CORPORATION, Tokyo (JP)

(21) Appl. No.: 16/070,027

(22) PCT Filed: Jan. 18, 2017
(86) PCT No.: PCT/JP2017/001568

§ 371 Date: Jul. 13, 2018

(30) Foreign Application Priority Data
Jan. 26, 2016 (JP) 2016-012122

(51) Int. Cl. G03B 21/14; G03B 21/00; G02B 7/09; G02B 7/28

(52) U.S. Cl. CPC G03B 21/142; G02B 7/28; G02B 7/09; G03B 21/006

(57) ABSTRACT

A projector including a light source apparatus, a modulation section, which functions as a light modulator that modulates light source light outputted from the light source apparatus, a projection system, which projects the modulated light modulated by the modulation section, and a focus adjusting section capable of adjusting the point where the modulated light is focused for each area of the modulated light. Defocus resulting from the shape of a projection surface and other factors can be suppressed, and an image can therefore be projected with the image brought into focus across a curved surface, an irregular surface, or any other surface.

### TECHNICAL FIELD

The present invention relates to a projector and a method for controlling the projector.

### BACKGROUND ART

In general, a projector is designed in many cases on the assumption that the projector projects (casts) an image on a flat surface, such as a wall and a ceiling. On the other hand, to project an image on a curved surface, there has been a proposed projector that deforms a projection image based on an approximation that corrects the distorted projection image resulting from the shape of the projection surface and projects the deformed projection image (see PTL 1, for example).

### CITATION LIST

### Patent Literature

PTL 1: JP-A-2004-320662

### SUMMARY OF INVENTION

### Technical Problem

The configuration of the related art can correct the distorted projection image resulting from the shape of the projection surface but cannot eliminate a shift of focus due to the differences in projection distance resulting from the shape of the projection surface.

An object of the invention is to suppress a shift of focus resulting from the shape of a projection surface and other factors to allow proj ection with an image brought into the focus across a curved surface, an irregular surface, or any other non-flat surface.

### SOLUTION TO PROBLEM

To achieve the object described above, the invention relates to a projector including a light source, a light modulator that modulates light source light emitted from the light source, a projection system that projects the modulated light modulated by the light modulator, and a focus adjuster capable of adjusting a point where the modulated light is focused for each area of the modulated light.

According to the invention, since the focus adjuster can adjust the point where the modulated light is focused for each area of the modulated light, defocus resulting from the shape of the projection surface and other factors can be suppressed, and an image can therefore be projected with the image brought into focus across a curved surface, an irregular surface, or any other surface.

According to the invention, in the configuration described above, the light modulator is divided into a plurality of areas, and the focus adjuster performs the focus adjustment on a divided area basis.

According to the invention, the focus adjustment can be performed on each of the divided areas of the light modulator to suppress defocus resulting from the shape of the projection surface and other factors.

According to the invention, in the configuration described above, the focus adjuster performs the focus adjustment for each pixel of the light modulator.

Since the focus adjustment is performed on a pixel basis, the invention is advantageous in regard with increase in the quality of a projected image.

According to the invention, in the configuration described above, the focus adjuster is disposed between the light modulator and the projection system.

According to the invention, the space created between the light modulator and the projection system provided in a projector or any other apparatus of related art can be used to dispose the focus adjuster.

According to the invention, in the configuration described above, the projector further includes the light modulator in plurality and a combining optical system that combines the modulated light fluxes modulated by the plurality of light modulators with one another, and the focus adjuster is disposed between the combining optical system and the projection system.

According to the invention, the spaces created between the plurality of light modulators and the combining optical system provided in a projector or any other apparatus of related art can each be used to dispose the focus adjuster.

According to the invention, in the configuration described above, the projector further includes the light modulator in plurality and the focus adjuster in plurality corresponding to the light modulators.

According to the invention, in a three-panel projector, for example, defocus resulting from the shape of the projection surface and other factors can be suppressed, and an image can be projected with the image brought into focus across a curved surface, an irregular surface, or any other surface.

According to the invention, in the configuration described above, the projector further includes a combining optical system that combines the modulated light fluxes from the plurality of light modulators with one another, and the plurality of focus adjusters are disposed between the plurality of light modulators and the combining optical system.

According to the invention, in a three-panel projector, for example, the spaces created between the plurality of light modulators and the combining optical system can each be used to dispose the plurality of focus adjusters.

According to the invention, in the configuration described above, the projector further includes a distance measurer that measures, for each of the areas of the modulated light, a separation distance to a projection area where the modulated light is projected and a controller that causes the focus adjuster to perform the focus adjustment for each of the areas of the modulated light based on the separation distance measured by the distance measurer.

According to the invention, since the focus adjustment is performed for each of the areas of the modulated light based on the separation distance to the projection area where the modulated light is projected, defocus resulting from the shape of the projection surface and other factors can suppressed, whereby an image can be projected with the image brought into focus across a curved surface, an irregular surface, or any other surface.

According to the invention, in the configuration described above, the controller causes the projection system to perform the focus adjustment and causes the focus adjuster to perform the focus adjustment for each of the areas of the modulated light based on the separation distance measured by the distance measurer to bring the modulated light in the area into focus on the projection area.

According to the invention, since the focus adjustment performed by the projection system and the focus adjustment performed by the focus adjuster for each of the areas of the modulated light thus bring the modulated light in the area into focus on the projection area, defocus resulting from the shape of the projection surface and other factors can suppressed, whereby an image can be projected with the image brought into focus across a curved surface, an irregular surface, or any other surface.

According to the invention, in the configuration described above, the controller causes the projection system to perform the focus adjustment based on a reference distance set based on the measured separation distance to bring the modulated light in each of the areas into focus in a position separate by the reference distance and causes the focus adjuster to perform the focus adjustment for each of the areas of the modulated light based on a difference between the reference distance and the measured separation distance to bring the modulated light in the area into focus on the projection area.

According to the invention, the focus adjustment performed by the projection system and the focus adjustment performed by the focus adjuster can be appropriately combined with each other to suppress defocus resulting from the shape of the projection surface and other factors. For example, when the reference distance is set at the shortest distance out of the measured separation distances, the focus adjustment performed by the focus adjuster only needs to be adjustment of increasing the focal length thereof.

According to the invention, in the configuration described above, the focus adjuster includes an electric focus variable lens that adjusts the focus for each of the areas.

According to the invention, the electric focus variable lens can be used to suppress defocus resulting from the shape of the projection surface and other factors.

The invention relates to a method for controlling a projector including a light source, a light modulator that modulates light source light emitted from the light source, a proj ection system that proj ects the modulated light modulated by the light modulator, and a focus adjuster capable of adjusting a point where the modulated light is focused for each area of the modulated light, the method including causing a distance measurer to measure, for each of the areas of the modulated light, a separation distance to a projection area where the modulated light in the area is proj ected and causing a controller to cause the focus adjuster to perform the focus adjustment for each of the areas of the modulated light based on the measured separation distance.

According to the invention, defocus resulting from the shape of the projection surface and other factors can be suppressed, and an image can therefore be projected with the image brought into focus across a curved surface, an irregular surface, or any other surface.

### BRIEF DESCRIPTION OF DRAWINGS

FIG. 1 shows the configuration of a light projecting section of a projector according to an embodiment of the invention.

FIG. 2 shows the cross-sectional structure of each focus adjusting section of the projector.

FIG. 3 diagrammatically shows the focus adjusting section along with a liquid crystal panel.

FIG. 4(A) shows an example of a case where the focus adjusting sections are each formed of a single part, and FIGS. 4(B) and 4(C) show examples in a case where the focus adjusting section are each formed of a part integrated with peripheral parts.

FIG. 5 is a block diagram showing the functional configuration of the projector.

FIG. 6 is a flowchart showing focus adjustment.

FIGS. 7(A) and 7(B) describe a liquid lens used in each of the focus adjusting sections.

FIG. 8 shows a configuration including only one focus adjusting section.

### DESCRIPTION OF EMBODIMENTS

An embodiment of the invention will be described below with reference to the drawings.

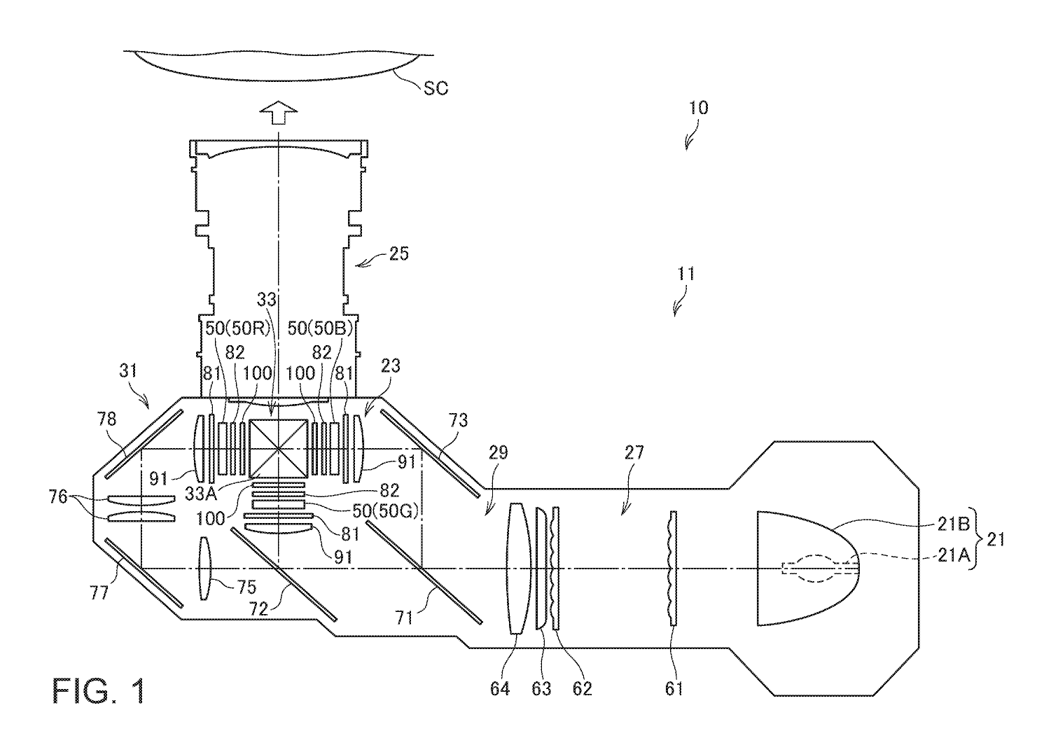

FIG. 1 shows the configuration of a light projecting section 11 of a projector 10 according to the embodiment of the invention.

The projector 10 includes the light projecting section 11, which projects an image on a projection surface SC, and functions as an image display apparatus that displays an image on the projection surface SC. The projection surface SC, on which the projector 1 can perform projection, is not limited to a flat surface and is any of variously shaped surfaces including a curved surface and an irregular surface. FIG. 1 shows a case where the proj ection surface SC is a curved surface . The projection target on which the projector 10 performs projection may be a screen and a wall surface or may be the surface of a three-dimensional object. In the present embodiment, the projection target is the curved projection surface SC by way of example. The installation of the projector 10 is not limited to specific installation and may be floor installation in which the projector 10 installed on a floor in front of the proj ection surface SC or suspension installation in which the projector 10 is hung from a ceiling.

The light projecting section 11 includes a light source apparatus 21, a modulation section 23, and a projection system 25. The light projecting section 11 further includes a light-source-side optical system 27, a separation optical system 29, a relay optical system 31, and a combining optical system 33.

The light source apparatus (light source) 21 includes a light emitter 21A and a reflector 21B. The light emitter 21A can, for example, be a halogen lamp, an ultrahigh-pressure mercurylamp,orametalhalide lamp. Thereflector21Bincludes, for example, a paraboloid mirror. Light radially emitted from the light emitter 21A is reflected off the reflector 21B, which converts the light into parallelized light. The reflector 21B causes the light from the light emitter 21A to travel toward the light-source-side optical system 27. The light source apparatus 21 does not necessarily include a lamp and may include a solid-state light source, such as an LED (light emitting diode) and a laser light source, or any other light source.

The modulation section 23 includes liquid crystal panels 50, which each function as a light modulator that modulates the light (light source light) from the light source apparatus (light source) 21. The liquid crystal panels 50 are transmissive liquid crystal panels and provided in correspondence with the three primary colors of light, which are R, G, and B. That is, the liquid crystal panels 50 include a liquid crystal panel 50R, which modulates light that is red (R) in color, a liquid crystal panel 50G, which modulates light that is green (G) in color, and a liquid crystal panel 50B, which modulates light that is blue (B) in color. The modulation section 23 does not necessarily include transmissive liquid crystal panels and may include reflective liquid crystal panels, digital mirror devices, or any other light modulators. Further, the modulation section 23 does not necessarily employ the configuration in which a plurality of modulators are provided and may employ a configuration in which only one light modulator is provided.

In the following description, the light that is red in color is called red light as appropriate, the light that is green in color is called green light as appropriate, and the light that is blue in color is called blue light as appropriate. That is, the liquid crystal panel 50R is a liquid crystal panel for red light, the liquid crystal panel 50G is a liquid crystal panel for green light, and the liquid crystal panel 50B is a liquid crystal panel for blue light. In a case where it is not particularly necessary to distinguish the liquid crystal panels 50R, 50G, and 50B from one another in the description, they are collectively called liquid crystal panels 50.

The light-source-side optical system 27 causes the light (light source light) incident from the light source apparatus (light source) 21 to exit as light having a uniform illuminance distribution. The light-source-side optical system 27 includes a first lens 61, a second lens 62, a polarization conversion element 63, and a superimposing lens 64 arranged along the optical path of the light source apparatus (light source) 21.

The first lens 61 and the second lens 62 are each an arrayed lens in which a plurality of microlenses are arranged in a matrix . The first lens 61 divides the light outputted from the light source apparatus 21 into a sub-light fluxes and causes them to exit. The second lens 62 along with the superimposing lens 64 forms images of the microlenses in the first lens 61 on each of the liquid crystal panels 50R, 50G, and 50B.

The polarization conversion element 63 is disposed between the second lens 62 and the superimposing lens 64. The polarization conversion element 63 converts the light having exited out of the second lens 62 and containing two types of polarized components into polarized light of one type that can be modulated by the liquid crystal panels 50R, 50G, and 50B. The polarization conversion element 63 allows one of the polarized components that is wastefully consumed in the form of heat in a case where no polarization conversion element 63 is provided to be used as the light that can be modulated by the liquid crystal panels 50, whereby the light use efficiency is increased.

The separation optical system 29 separates the light from the light-source-side optical system 27 into the red light (R), the green light (G), and the blue light (B). The separation optical system 29 in the present embodiment includes two dichroic mirrors 71 and 72 and a reflection mirror 73. The dichroic mirror 71, which receives the light from the light-source-side optical system 27, transmits the red light and the green light but reflects the blue light. The reflection mirror 73 reflects the blue light reflected off the dichroic mirror 71 to guide the blue light to the liquid crystal panel 50B in the modulation section 23. The dichroic mirror 72, which receives the light from the dichroic mirror 71, transmits the red light and reflects the green light to guide the green light to the liquid crystal panel 50G in the modulation section 23.

The relay optical system 31 includes a light-incident-side lens 75, relay lenses 76, and reflection mirrors 77 and 78 and guides the red light having passed through the dichroic mirror 72 to the liquid crystal panel 50R for red light. The relay optical system 31 has been described with reference to the case where the red light out of the three color light fluxes is guided, but not necessarily, and the blue light or the green light may be guided, for example, by changing the functions of the dichroic mirrors 71 and 72.

The modulation section 23 modulates light incident thereon based on image data (image signal). The modulation section 23 includes three light-incident-side polarizers 81, on which the color light fluxes from the separation optical system 29 and the relay optical system 31 are incident, and the three liquid crystal panels 50R, 50G, and 50B, which are disposed on the light exiting side of the light-incident-side polarizers 81. The modulation section 23 further includes three light-exiting-side polarizers 82, which are disposed on the light exiting side of the liquid crystal panels 50R, 50G, and 50B.

The light-incident-side polarizers 81 transmit only the light polarized in a fixed direction out of the color light fluxes separated by the separation optical system 29 but absorbs the remainder of the color light fluxes. The light-exiting-side polarizers 82 transmit only light polarized in a predetermined direction out of the modulated light outputted from the liquid crystal panels 50 but absorbs the remainder of the color light fluxes. The light-incident-side polarizers 81 and the light-exiting-side polarizers 82 are so disposed that the directions of the polarization axes thereof are perpendicular to each other. Field lenses 91 are disposed on the light incident side of the light-incident-side polarizers 81.

The field lenses 91 have an optical effect of converting the sub-light fluxes having exited out of the second lens 62 into light fluxes parallel to the center axes (principal rays) of the sub-light fluxes. That is, the color light fluxes separated by the separation optical system 29 pass through the field lenses 91 and the light-incident-side polarizers 81 and impinge on the liquid crystal panels 50R, 50G, and 50B.

The liquid crystal panels 50R, 50G, and 50B are each, for example, an active-matrix transmissive liquid crystal panel using a polysilicon TFT (thin film transistor) as a switching element and is also called a TFT liquid crystal panel. The liquid crystal panels 50R, 50G, and 50B modulate the color light fluxes incident thereon in accordance with image information (signals) on a color light basis and cause the modulated light fluxes on a color light basis to enter the combining optical system 33 via the light-exiting-side polarizers 82.

The combining optical system 33 includes a dichroic prism 33A and combines the three color modulated light fluxes outputted from the liquid crystal panels 50R, 50G, and 50B via the light-exiting-side polarizers 82 with one another. The dichroic prism 33A is a cross dichroic prism in which a dielectric multilayer film that reflects the red light and a dielectric multilayer film that reflects the blue light are disposed in a roughly X-letter shape along the interfaces between four rectangular prisms.

The projection optical system 25 includes a projection lens that is not shown but is disposed on the light exiting side of the combining optical system 33, and the projection lens enlarges the combined full-color light from the combining optical system 33 and causes the enlarged light to exit toward the projection surface SC. The projection optical system 25 allows focus adjustment, for example, by employing a configuration in which the position of the projection lens is variable.

The projector 10 according to the present embodiment includes focus adjusting sections (focus adjuster) 100, which are provided between the liquid crystal panels 50R, 50G, 50B and the combining optical system 33 and can adjust the focus on a modulated light area basis.

The focus adjusting sections 100 are each a lens array including microlenses capable of changing the refractive index for each area of the modulated light passing through the corresponding one of the liquid crystal panels 50R, 50G, and 50B, more specifically, a liquid crystal lens array in which the microlenses are each formed of a liquid crystal lens. The microlenses are so arranged in a matrix that that one microlens corresponds to a segment formed of several pixels of each of the liquid crystal panels 50 (50R, 50G, and 50B). The microlenses may instead be provided in correspondence with the pixels of each of the liquid crystal panels 50 in one-to-one relationship.

Changing the refractive index of each of the microlenses allows the modulated light fluxes passing through the liquid crystal panels 50 to be focused at variable points for each of the microlenses through which the modulated light flux passes. In the present embodiment, in which the microlenses are disposed in correspondence with the segments each formed of above-mentioned several pixels of the liquid crystal panels 50, the focus can be adjusted for each of sub-modulated light fluxes passing through the segments described above. In other words, the point where each of the modulated light fluxes is focused can be adjusted for each of a plurality of predetermined divided areas of each of the modulated light fluxes.

The refractive indices of the plurality of microlenses are not necessarily variable on a microlens basis. Instead, the microlenses may be allocated to a plurality of groups, and the refractive indices of the microlenses are controlled on a group basis for the focus adjustment.

The plurality of predetermined areas described above are areas in a matrix regularly divided along two directions corresponding to the horizontal and vertical directions of each of the liquid crystal panels 50. The focus on the projection surface SC can therefore be adjusted for each of the areas arranged in the horizontal and vertical directions.

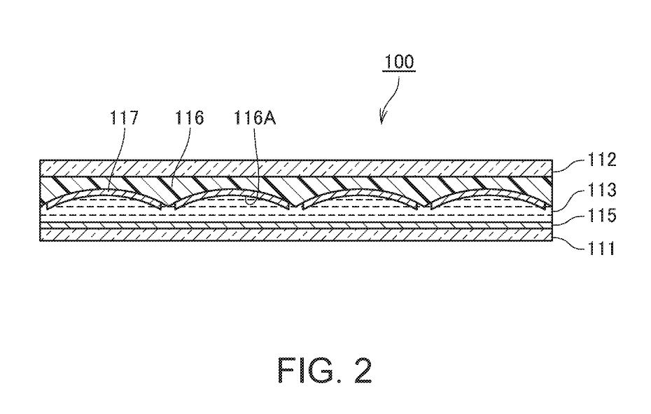

FIG. 2 shows the cross-sectional structure of each of the focus adjusting sections 100.

The focus adjusting section 100 has a liquid crystal panel structure in which a pair of transparent substrate 111 and 112, which are made of a transparent material, such as glass, (the transparent substrate 111, which is one of the transparent substrates, is hereinafter called a “first substrate 111,” and the second transparent substrate 112, which is the other transparent substrate, is hereinafter called a “second substrate 112”) sandwich a liquid crystal layer 113.

Stripe-shaped first electrodes 115, which are formed of a plurality of band-shaped electrodes extending in the horizontal direction of each of the liquid crystal panels 50 and arranged in parallel to each other, are provided on the inner surface of the first substrate 111. The first electrodes 115 are each formed of a transparent electrically conductive film made, for example, of ITO (indium tin oxide).

A lens-shaped layer 116, which is made of a resin having high optical transparency, is provided over the entire inner surface of the second substrate 112. The lens-shaped layer 116 imparts lens shapes to the liquid crystal layer 113, and a plurality of recesses 116A, which are each formed of a curved surface, are so provided across the lens-shaped layer 116 that the liquid crystal layer 113 sandwiched between the first substrate 111 and the second substrate 112 has convex-lens shapes.

Stripe-shaped second electrodes 117, which are formed of a plurality of band-shaped electrodes extending in the vertical direction of each of the liquid crystal panels 50 and arranged in parallel to each other, are provided on the inner surface of the lens-shaped layer 116 on the second substrate 112. The second electrodes 117 are formed along the recesses 116A of the lens-shaped layer 116. The second electrodes 117 are also each formed of a transparent electrically conductive film made, for example, of ITO, as are the first electrodes 115. The liquid crystal material that forms the liquid crystal layer 113 can be a liquid crystal material having positive dielectric anisotropy or negative dielectric anisotropy.

In the configuration described above, when voltage is applied to the spaces between the first electrodes 115 and the second electrodes 117, the orientation of the liquid crystal material in the liquid crystal layer 113 can be changed in the positions where the first electrodes 115 and the second electrodes 117 intersect each other.

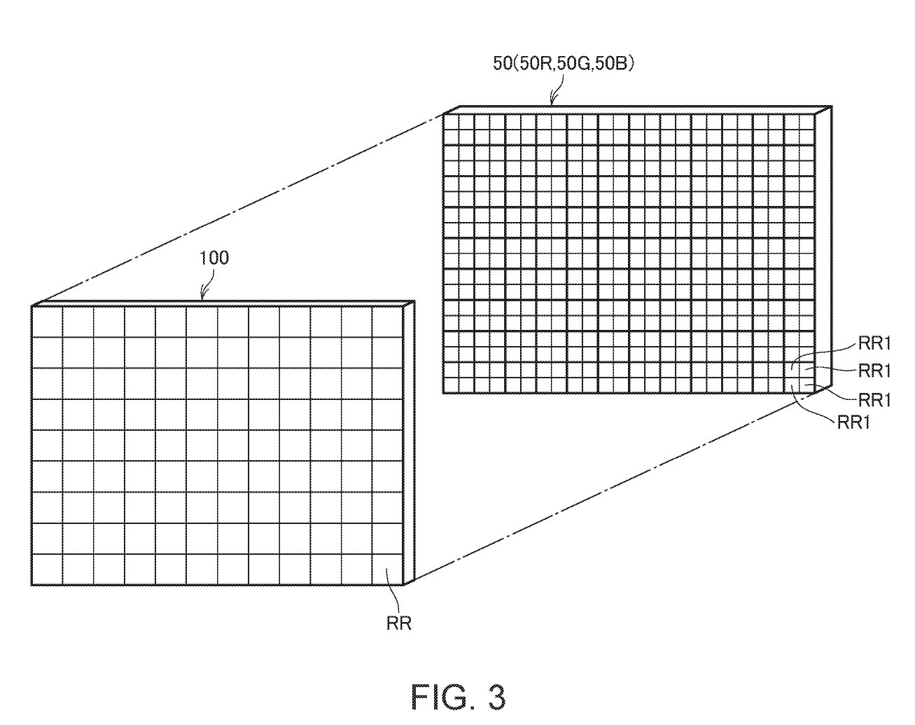

The focus adjusting section 100 is divided into areas RR along the directions corresponding to the horizontal and vertical directions of each of the liquid crystal panels, as diagrammatically shown in FIG. 3, and the refractive index of each of the areas RR can be changed based on what is called simple matrix driving.

FIG. 3 shows a case where the areas RR of the focus adjusting section 100 are formed in correspondence with areas formed of four pixels (two pixels in horizontal direction and two pixels in vertical direction) of each of the liquid crystal panels 50. In FIG. 3, reference character RR1 represents the area of one pixel of each of the liquid crystal panels 50.

In each of the focus adjusting sections 100, the liquid crystal material of the liquid crystal layer 113 and the resin material of the lens-shaped layer 116 are so selected that the refractive index of the liquid crystal layer 113 coincides with the refractive index of the lens-shaped layer 116 when no voltage is applied (no voltage application state). Therefore, in a case where the focus does not need to be changed for each of the areas RR of the modulated light flux, the no voltage application state causes no refraction of the light at the interface between the liquid crystal layer 113 and the lens-shaped layer 116, so that the focus is not changed.

On the other hand, in the case where voltage is applied to the spaces between the first electrodes 115 and the second electrodes 117, the orientation of the liquid crystal material in the liquid crystal layer 26 changes in accordance with the applied voltage. Adjusting the applied voltage allows adjustment of the refractive index at the interface between the liquid crystal layer 113 and the lens-shaped layer 116.

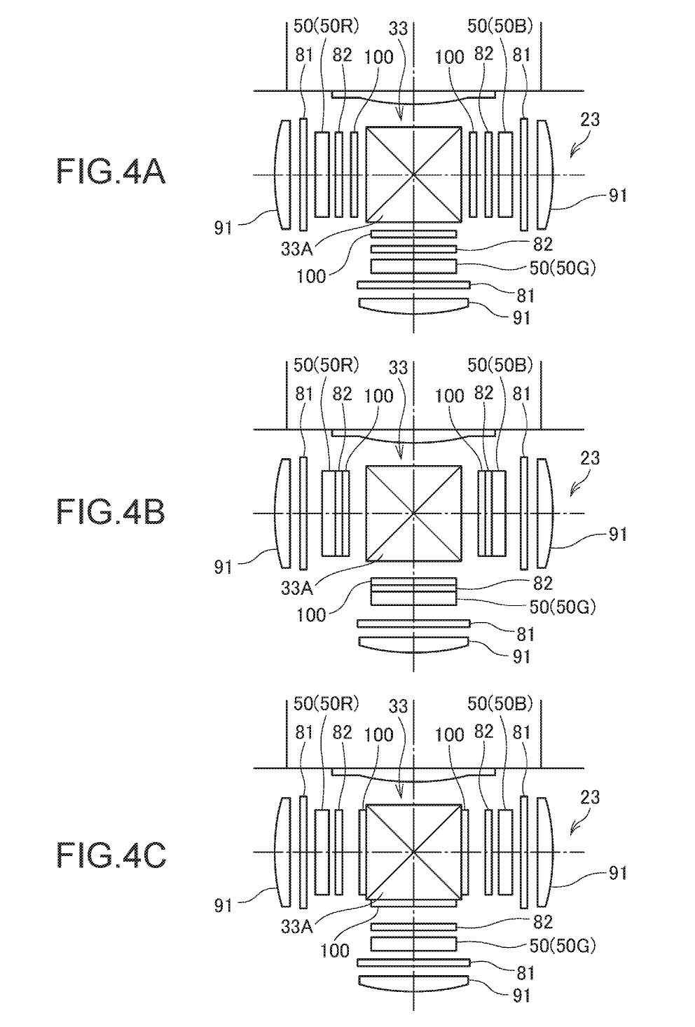

The focus adjusting sections 100 may each be formed of a single part or a part integrated with peripheral parts. FIG. 4(A) shows an example in the case where the focus adjusting sections 100 are each formed of a single part, and FIGS. 4(B) and 4(C) show examples in the case where the focus adjusting sections 100 are each formed of a part integrated with peripheral parts.

In the case where the focus adjusting sections 100 are each formed of a single part, the gap between the light-exiting-side polarizer 82 and the dichroic prism 33A of the projector of related art is used to readily dispose the focus adjusting section 100, as shown in FIG. 4A.

FIG. 4(B) shows a case where the focus adjusting sections 100 are integrated with the light-exiting-side polarizers 82. In FIG. 4(B), the light-exiting-side polarizers 82 are also integrated with the light-exiting-side surfaces of the liquid crystal panels 50. Integrating the focus adjusting sections 100, the light-exiting-side polarizers 82, and the liquid crystal panels 50 with one another allows the space where these three parts are disposed to be minimized and the number of parts to be reduced.

FIG. 4(C) shows a case where the focus adjusting sections 100 are integrated with the light-incident-side surfaces of the dichroic prism 33A. Also in this case, the space where the focus adjusting sections 100 are disposed can be reduced as compared with the case shown in FIG. 4(A).

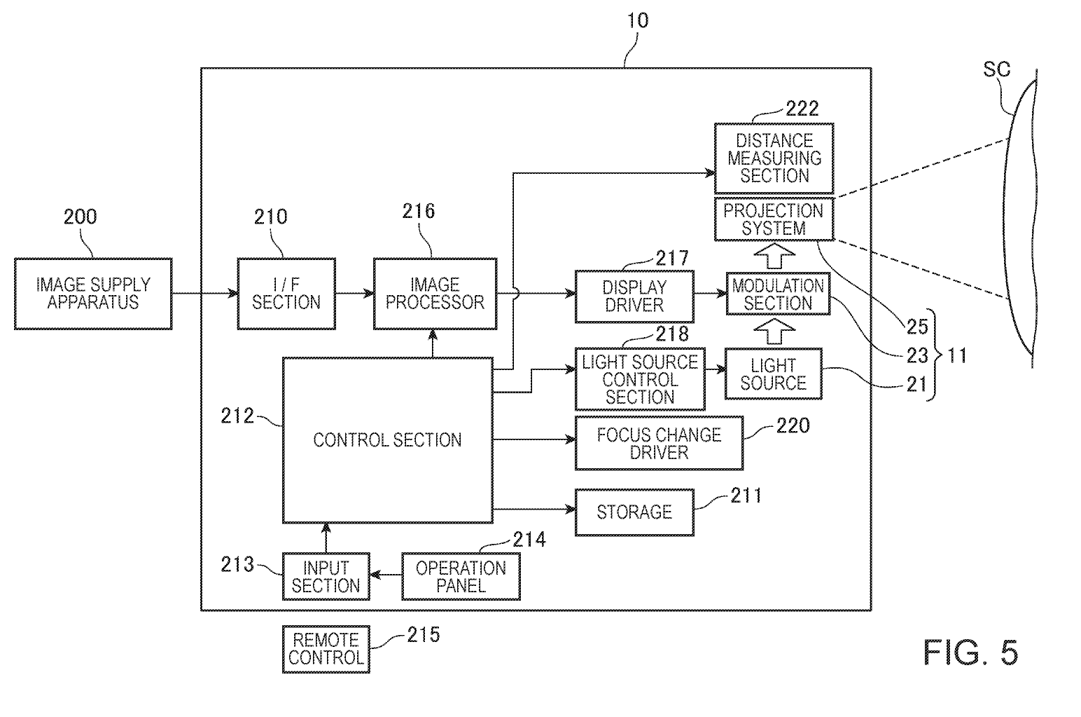

FIG. 5 is a block diagram showing the functional configuration of the projector 10.

The projector 10 includes an interface (I/F) section 210, to which an external image supply apparatus 200 is connected, and a variety of sets of image data (including image signals) are inputted to the projector 10 via the I/F section 210.

The image supply apparatus 200 is an image output apparatus, such as a DVD player or any other image reproducing apparatus, a digital television tuner or any other broadcasting receiver, a video game console, or a personal computer. The image supply apparatus 200 may instead, for example, be a communication apparatus that wirelessly communicates with a personal computer or any other apparatus to receive image data. The image data inputted from the image supply apparatus 200 to the projector 10 maybe data (signal) formed of motion images or still images. The projector 10 may instead read image data stored in a storage 211 in the projector 10 or on a storage medium externally connected to the projector 10 and display an image on the projection surface SC based on the image data.

The projector 10 further includes the storage 211, a control section (controller) 212, an input section 213, an operation panel 214, a remote control 215, an image processor 216, a display driver 217, and a light source control section 218 in addition to the light projecting section 11 and the focus adjusting section 100.

The storage 211 stores a variety of data, programs, and other pieces of information processed by the projector 10. The storage 211 is, for example, a RAM (random access memory), a register, an HDD (hard disk drive), or an SSD (solid state drive).

The control section 212 executes the programs stored in the storage 211 to control each portion of the projector 10. The input section 213 receives a user's instruction via the operation panel 214 and the remote control 215 and notifies the control section 212 of the user's instruction. That is, the control section 212 controls each portion of the projector 10 based, for example, on the user's instruction.

The image processor 216 is responsible for image processing performed on the inputted image data under the control of the control section 212. For example, the image processor 216 performs resizing, trapezoidal correction, and other types of processing as appropriate in such a way that an image corresponding to the image data and having an adequate size and other factors is displayed on the projection surface SC. The image processor 216 further outputs R, G, and B image signals representing the grayscales at the pixels of the liquid crystal panels 50R, 50G, and 50B, which are provided in the light projecting section 11, based on the image having undergone the image processing described above.

The display driver 217 drives the liquid crystal panels 50R, 50G, and 50B based on the image signals outputted by the image processor 216 to set the grayscales of the pixels of the liquid crystal panels 50R, 50G, and 50B to draw images on a frame (screen) basis in the liquid crystal panels 50R, 50G, and 50B.

The light source control section 218 turns on the light source apparatus 21 and controls the amount of light from the light source apparatus 21 under the control of the control section 212.

The projector 10 according to the present embodiment further includes a focus change driver 220, which drives the focus adjusting sections 100, and a distance measuring section (distance measurer) 222, which measures the distance to the projection surface SC.

The focus change driver 220 drives the focus adjusting sections 100 based on voltage under the control of the control section 212. The focus change driver 220 thus changes the point where the modulated light flux having passed through each of the liquid crystal panels 50 is focused for each of the areas RR (FIG. 3), to which the liquid crystal panel 50 is horizontally and vertically divided.

The distance measuring section 222 measures the distance to a projection area where the modulated light flux in each of the areas RR is projected under the control of the control section 212.

The distance measuring section 222 in the present embodiment is formed of a laser range finder and measures the separation distance from the projector 10 to each of the projection areas (areas of projection surface SC that correspond to areas RR). The distance measuring section 22 is not limited to a laser range finder and can be any of a wide variety of known distance measuring devices, such as a configuration in which a plurality of cameras are used to measure the distance.

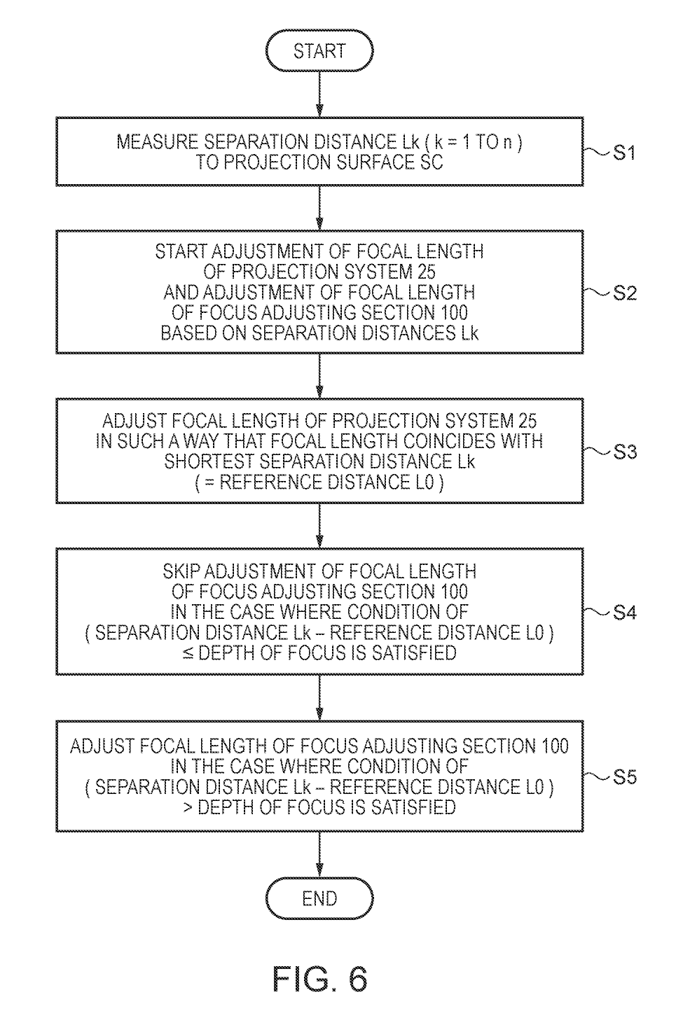

The focus adjustment will be described with reference to the flowchart shown in FIG. 6.

The control section 212 causes the distance measuring section 222 to scan the entire projection surface SC with a laser beam to measure, for each of the areas RR of each of the modulated light fluxes, the separation distance Lk to the projection area where the modulated light flux in the area RR is projected (step S1). The value k is an integer ranging from 1 to n, and the value n is the number of projection areas on which the modulated light flux in the areas RR are projected, that is, the number of areas where the focus can be separately adjusted (areas RR).

The control section 212 causes the storage 211 to store information on the measured separation distances Lk. The separation distances Lk may each be the average of the separation distances to a plurality of points in the projection area where the modulated light flux in each of the areas RR is projected or maybe the separation distance in a representative position (central position, for example) of the projection area.

The control section 212 starts the focus adjustment based on the measured separation distances Lk (step S2). The focus adjustment includes adjustment of the focal length of the projection system 25 and adjustment of the focal length of the focus adjusting section.

The control section 212 first identifies the shortest separation distance Lk among the measured separation distances Lk and adjusts the focal length of the projection system 25 in such a way that the focal length coincides with the shortest separation distance Lk (hereinafter referred to as “reference distance L0”) (step S3). In this case, the control section 212 automatically adjusts the focal length of the projection system 25. Instead, the user may manually adjust the focal length of the projection system 25. In this case, it is preferable to guide the user to adjust the focal length to coincide with the shortest separation distance Lk with the aid of image display or voice.

As described above, since the projection system 25 is so adjusted that the focal point thereof coincides with the closest portion of the projection surface SC, the focus adjustment performed by the focus adjusting section 100 only needs to be adjustment of increasing the focal length thereof. In this case, at the start of the adjustment of the focal length of the projection system 25 shown in step S2, the focal length of the focus adjusting section 100 is minimized (no voltage application state or no refraction state in present configuration), whereby a wide focus adjustment range can be provided.

The control section 212 then adjusts the focal length of the focus adjusting section 100 with reference to the reference distance L0. Specifically, the control section 212 determines that an in-focus situation is achieved in a case where a condition of (separation distance Lk—reference distance L0) smaller than or equal to the depth of focus of the projection system 25 is satisfied. The control section 212 skips the adjustment of the focal length of the focus adjusting section 100 for a separation distance Lk (relevant value out of k=1 to n) that satisfies the condition described above (step S4).

That is, (separation distance Lk—reference distance L0) represents defocus, and in a case where the amount of defocus falls within the depth of focus of the projection system 25, the adjustment of the focal length of the focus adjusting section 100 is not performed. The adjustment of the focal length of the focus adjusting section 100 can thus be omitted, whereby the period required for the adjustment can be shortened.

On the other hand, the control section 212 determines that no in-focus situation is achieved in a case where a condition of (separation distance Lk—reference distance L0) greater than the depth of focus of the projection system 25 is satisfied, and the control section 212 performs the adjustment of the focal length of the focus adjusting section 100 for the separation distance Lk (relevant value out of k=1 to n) (step S5). That is, the control section 212 performs the adjustment of the focal length of the focus adjusting section 100 only for defocus greater than the depth of focus.

In the case where the adjustment of the focal length of the focus adjusting section 100 is performed, the control section 212 determines a focus adjustment distance (separation distance Lk—reference distance L0—depth of focus) and identifies voltage necessary for adjustment of the focus adjustment distance. The control section 212 then causes the focus change driver 220 to apply the identified voltage to the area of the focus adjusting section 100 that corresponds to a predetermined area RR corresponding to the area where the focus adjustment is performed. The focus is thus appropriately adjusted.

The identification of the voltage necessary for the adjustment of the focus adjustment distance may be performed as follows: For example, table data that relates focal point adjustment distances to voltages is stored in the storage 211 in advance; and the control section 212 may identify relevant voltage based on the table data. Instead, the table data can be replaced with mathematical expression data representing the relationship between a focus adjustment distance and voltage relevant thereto, and relevant voltage can be identified based on the mathematical expression data. The focus adjustment has been described.

The focus adjustment may be automatically initiated by the control section 212 at a predetermined timing set after the projector 10 is installed or may be initiated by the control section 212 when the user issues an instruction.

As described above, the projector 10 according to the present embodiment includes the light source apparatus 21, the modulation section 23, which modulates the light source light outputted from the light source apparatus 21, and the projection system 25, which projects the modulated light fluxes modulated by the modulation section 23. The projector 10 further includes the focus adjusting sections 100, which can perform the focus adjustment on a modulated light area basis . The thus configured projector 10 can suppress defocus resulting from the shape of the projection surface SC and other factors and can therefore project an image with the image brought into focus across a curved surface, an irregular surface, or any other surface.

The modulation section 23 is divided into a plurality of areas, and the focus adjusting sections 100 perform the focus adjustment on a divided area basis. The focus adjustment can therefore be performed on each of the divided areas of the modulation section 23 to suppress the defocus resulting from the shape of the projection surface SC and other factors.

The focus adjusting sections 100 each use the liquid crystal lens, which performs the focus adjustment on each of the divided areas of the modulation section 23, and the liquid crystal lens can be used to suppress defocus resulting from the shape of the projection surface SC and other factors. A known liquid crystal lens technology can thus be applied.

Since the focus adjusting sections 100 are disposed between the modulation section 23 and the projection system 25, the space created between the modulation section 23 and the projection system 25 can be used to dispose the focus adjusting sections 100. That is, the configuration of a projector of related art including the modulation section 23 and the projection system 25 can be used as it is to allow the focus adjusting sections 100 to be readily disposed.

The projector 10 according to the present embodiment further includes the liquid crystal panels 50R, 50G, and 50B, which function as a plurality of light modulators, and the combining optical system 33, which combines the modulated light fluxes from the liquid crystal panels 50R, 50G, and 50B with one another. The focus adjusting sections 100 are disposed between the combining optical system 33 and the liquid crystal panels 50R, 50G, 50B. The space created between the plurality of liquid crystal panels 50R, 50G, 50B and the combining optical system 33 provided in a projector of related art and other apparatus can therefore be used to dispose the focus adjusting sections 100.

The projector 10 further includes the plurality of liquid crystal panels 50R, 50G, and 50B and the plurality of focus adjusting sections 100 corresponding to the liquid crystal panels 50R, 50G, and 50B. Therefore, in what is called a three-panel projector, defocus resulting from the shape of the projection surface SC and other factors can be suppressed, and an image can be projected with the image brought into focus across a curved surface, an irregular surface, or any other surface.

Further, the combining optical system 33, which combines the modulated light fluxes from the liquid crystal panels 50R, 50G, and 50B with one another, is provided, and the plurality of focus adjusting sections 100 are disposed between the liquid crystal panels 50R, 50G, 50B and the combining optical system 33. The configuration of what is called a three-panel projector can therefore be used as it is to suppress the defocus and project an image with the image brought into focus across a curved surface, an irregular surface, or any other surface.

The focus adjusting sections 100 are each formed of a lens array including a plurality of microlenses. The focus adjustment can therefore be performed for each of the segments each formed of several pixels of each of the liquid crystal panels 50R, 50G, and 50B or for each of the pixels of each of the liquid crystal panels 50R, 50G, and 50B. Precise focus adjustment on a several-pixel basis or a single-pixel basis can therefore be performed and is advantageous in regard with increase in the quality of a projected image.

The projector 10 further includes the distance measuring section 222 and the control section 212. The distance measuring section 222 measures, for each of the areas RR of each of the modulated light fluxes modulated by the modulation section 23, the separation distance Lk to the projection area where the modulated light flux in the area RR is projected. The control section 212 then causes the focus adjusting sections 100 to perform the focus adjustment for each of the areas RR of the modulated light fluxes based on the measured separation distances Lk. Defocus resulting from the shape of the projection surface SC and other factors can therefore suppressed, whereby an image can be projected with the image brought into focus across a curved surface, an irregular surface, or any other surface.

Further, the control section 212 causes the projection system 25 to perform the focus adjustment and causes the focus adjusting sections 100 to perform the focus adjustment for each of the areas RR of each of the modulated light fluxes based on the measured separation distance Lk to bring the modulated light flux in the area RR into focus on the corresponding projection area. Since the focus adjustment performed by the projection system 25 and the focus adjustment performed by the focus adjusting sections 100 for each of the areas RR of each of the modulated light fluxes thus bring the modulated light flux in the area into focus on the corresponding projection area, defocus resulting from the shape of the projection surface and other factors can suppressed, whereby an image can be projected with the image brought into focus across a curved surface, an irregular surface, or any other surface.

Further, the control section 212 causes the projection system 25 to perform the focus adjustment based on the reference distance L0 set based on the measured separation distances Lk to bring the modulated light fluxes in each of the areas RR into focus in a position separate by the reference distance L0 and causes the focus adjusting sections 100 to perform the focus adjustment for each of the areas RR of the modulated light fluxes based on the differences between the reference distance L0 and the measured separation distances Lk to bring the modulated light flux in the area RR into focus on the corresponding projection area. The focus adjustment performed by the projection system 25 and the focus adjustment performed by the focus adjusting sections 100 can thus be appropriately combined with each other to suppress defocus resulting from the shape of the projection surface SC and other factors. For example, when the reference distance L0 is set at the shortest distance out of the measured separation distances Lk, the focus adjustment performed by the focus adjusting sections 100 only needs to be adjustment of increasing the focal length thereof, as described above.

In the present embodiment, as a method for controlling the projector 10, the distance measuring section 222 measures, for each of the areas RR of each of the modulated light fluxes modulated by the modulation section 23, the separation distance Lk to the projection area where the modulated light flux in the area RR is projected. The control section 212 then causes the projection system 25 to perform the focus adjustment and causes the focus adjusting sections 100 to perform the focus adjustment for each of the areas RR of each of the modulated light fluxes based on the measured separation distance Lk. Defocus resulting from the shape of the projection surface SC and other factors can therefore suppressed, whereby an image can be projected with the image brought into focus across a curved surface, an irregular surface, or any other surface.

As the focus adjustment described above, the control section 212 causes the projection system 25 to perform the focus adjustment based on the reference distance L0 set based on the measured separation distances Lk to bring the modulated light fluxes in each of the areas RR into focus in a position separate by the reference distance L0. The control section 212 then causes the focus adjusting sections 100 to perform the focus adjustment for each of the areas RR of the modulated light fluxes based on the differences between the reference distance L0 and the measured separation distances Lk to bring the modulated light flux in the area RR into focus on the corresponding projection area.

The focus adjustment performed by the projection system 25 and the focus adjustment performed by the focus adjusting sections 100 can thus be appropriately combined with each other to suppress defocus resulting from the shape of the projection surface SC and other factors.

The case where the reference distance L0 is set at the shortest distance among the measured separation distances Lk has been described, but not necessarily. For example, the reference distance L0 may be set to the longest distance among the measured separation distances Lk, and the focus adjustment performed by the focus adjusting sections 100 may be so performed that the focal length thereof is decreased. Still instead, the reference distance L0 may be set at an intermediate distance among the measured separation distances Lk, and the focus adjusting sections 100 may perform the focus adjustment with reference to the intermediate distance.

The embodiment described above is a preferable embodiment of the invention and is not intended to limit the scope of the invention, and a variety of variations are conceivable to the extent that they do not depart from the substance of the invention. For example, the above-mentioned embodiment has been described with reference to the case where the focus adjusting sections 100 each have the configuration in which a liquid crystal lens, which is an electric focus variable lens, is used, but not necessarily, and a liquid lens or any other electric focus variable lens may be used.

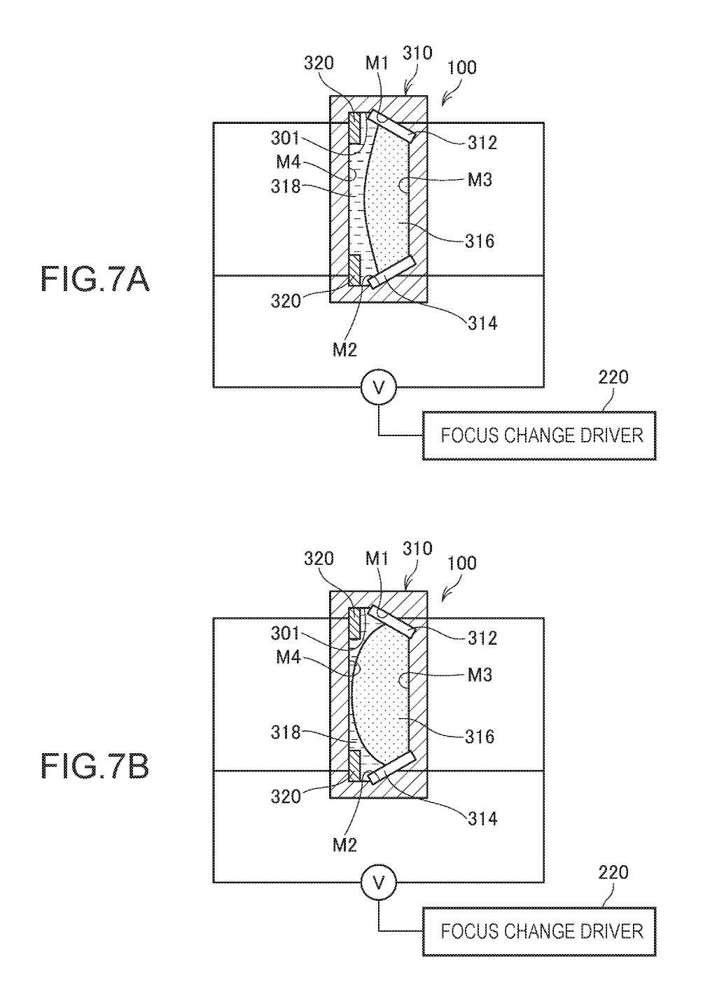

A liquid lens is a lens capable of changing the curvature thereof. In the case where a liquid lens is employed, the focus adjusting sections 100 are each preferably formed of a liquid lens array in which the microlenses arranged in a matrix are replaced with liquid lenses. An example of the configuration of each of the liquid lenses in this case will be described with reference to FIGS. 7(A) and 7(B).

A liquid lens 300 includes a sealing member (container) 310, which is made of a transparent material and has a recess 301, as shown in FIGS. 7(A) and 7(B). The sealing member 310 has a first electrode 312 and a second electrode 314 formed on inner side surfaces M1 and M2 of the recess 301, which are separate from each other . An oil droplet 316, which is in contact with the first electrode 312 and the second electrode 314, and an aqueous electrolyte 318, which covers the oil droplet 316, are provided between the electrodes 312 and 314.

Transparent electrodes 320 are provided on an opposing surface M4, which opposes a bottom surface M3 of the recess 301 of the sealing member 310. The first electrode 312, the second electrode 314, and the transparent electrodes 320 are each formed of a transparent electrically conductive film made, for example, of ITO. Voltage is applied in a variety of manners by the focus change driver 220 to the first electrode 312, the second electrode 314, and the transparent electrodes 320. The voltage is supplied, for example, in the form of a sinusoidal waveform.

The focus change driver 220 changes the applied voltage under the control of the control section 212 to draw the electrolyte 318 into the space between the first electrode 312 and the second electrode 314. The curvature of the oil droplet 316 can be relatively small, as shown in FIG. 7(A), and can be relatively large, as shown in FIG. 7(B). The change in the curvature changes the refractive index of the liquid lens for focus adjustment.

The configuration using the liquid lens also allows the same layout in the embodiment described above and provides the variety of same effects as those provided by the embodiment described above. The liquid lens is also not limited to the configuration described above, and a wide variety of known configurations can be applied.

The focus adjusting sections 100 do not necessarily use a liquid crystal lens or a liquid lens and may instead use a gel variable lens, a lens using an electro-optical crystal, or any other electric focus variable lens.

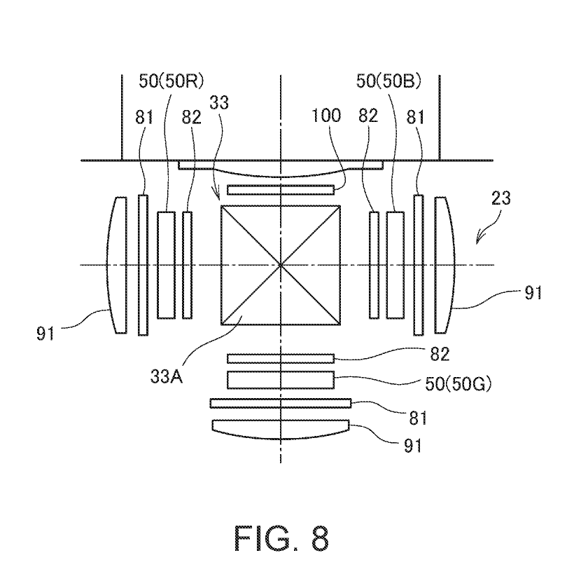

In the embodiment described above, the configuration including three focus adjusting sections 100 corresponding to the liquid crystal panels 50R, 50G, and 50B has been shown, but a configuration including only one focus adjusting section 100 may be employed. In this case, for example, the focus adjusting section 100 may be disposed between the dichroic prism 33A and the projection system 25, as shown in FIG. 8. The focus adjusting section 100 may be formed of a single part or may be integrated with the dichroic prism 33A.

In the embodiment described above, the configuration in which the focus adjusting sections 100 are disposed in the projector 10 (on light incident side of projection system 25) has been shown by way of example. Instead, the focus adjusting section 100 may be disposed in the projection system 25. For example, the focus adjusting section 100 may be attached to the light exiting side of the projection system 25, or the focus adjusting section 100 may be provided in the projection system 25 itself.

The configuration of the projector 10 shown in FIG. 5 and other figures represents the functional configuration and is not intended to limit a specific form in which the functions are implemented. That is, hardware corresponding to each of the functional portions is not necessarily implemented, and a single processor that executes a program can, of course, achieve the functions of the plurality of functional portions. Further, part of the functions achieved by software in the embodiment described above maybe achieved by hardware, or part of the functions achieved by hardware may be achieved by software.

### REFERENCE SIGNS LIST

10: Projector, 11: Light projecting section, 21: Light source apparatus (light source), 23: Modulation section (light modulator), 25: Projection system, 27: Light-source-side optical system, 29: Separation optical system, 31: Relayoptical system, 33: Combining optical system, 100: Focus adjusting section (focus adjuster), 212: Control section (controller), 222: Distance measuring section (distance measurer), SC: Projection surface

1. A projector comprising:
a light source;
a light modulator that modulates light source light emitted from the light source;
a projection system that projects the modulated light modulated by the light modulator; and
a focus adjuster capable of adjusting a point where the modulated light is focused for each area of the modulated light.

2. The projector according to claim 1, wherein
the light modulator is divided into a plurality of areas, and
the focus adjuster performs the focus adjustment on a divided area basis.

3. The projector according to claim 1 or 2,claim 1, wherein the focus adjuster performs the focus adjustment for each pixel of the light modulator.

4. The projector according to claim 1, wherein the focus adjuster is disposed between the light modulator and the projection system.

5. The projector according to claim 4, wherein
the projector further comprises light modulator in plurality and a combining optical system that combines the modulated light fluxes modulated by the plurality of light modulators with one another, and
the focus adjuster is disposed between the combining optical system and the projection system.

6. The projector according to claim 1, wherein the projector further comprises the light modulator in plurality and the focus adjuster in plurality corresponding to the light modulators.

7. The projector according to claim 6, wherein
the projector further comprises a combining optical system that combines the modulated light fluxes from the plurality of light modulators with one another, and
the plurality of focus adjusters are disposed between the plurality of light modulators and the combining optical system.

8. The projector according to any of claims 1 to 7,claim 1, wherein the projector further comprises:
a distance measurer that measures, for each of the areas of the modulated light, a separation distance to a projection area where the modulated light is projected; and
a controller that causes the focus adjuster to perform the focus adjustment for each of the areas of the modulated light based on the separation distance measured by the distance measurer.

9. The projector according to claim 8, wherein the controller causes the projection system to perform the focus adjustment and causes the focus adjuster to perform the focus adjustment for each of the areas of the modulated light based on the separation distance measured by the distance measurer to bring the modulated light in the area into focus on the projection area.

10. The projector according to claim 9, wherein
the controller
causes the projection system to perform the focus adjustment based on a reference distance set based on the measured separation distance to bring the modulated light in each of the areas into focus in a position separate by the reference distance and
causes the focus adjuster to perform the focus adjustment for each of the areas of the modulated light based on a difference between the reference distance and the measured separation distance to bring the modulated light in the area into focus on the projection area.

11. The projector according to claim 1, wherein the focus adjuster includes an electric focus variable lens that adjusts the focus for each of the areas.

12. A method for controlling a projector including a light source, a light modulator that modulates light source light emitted from the light source, a projection system that projects the modulated light modulated by the light modulator, and a focus adjuster capable of adjusting a point where the modulated light is focused for each area of the modulated light, the method comprising:
causing a distance measurer to measure, for each of the areas of the modulated light, a separation distance to a projection area where the modulated light in the area is projected; and
causing a controller to cause the focus adjuster to perform the focus adjustment for each of the areas of the modulated light based on the measured separation distance.
